(19) United States
(12) Patent Application Publication
(10) Pub. No.: US 2013/0004737 A1
(43) Pub. Date: Jan. 3, 2013

(54) Decorating Layer of Laminated Product and Method of Manufacture Thereof

(76) Inventor: Chi-Shih Lee, Taichung City (TW)

(21) Appl. No.: 13/349,753

(22) Filed: Jan. 13, 2012

Related U.S. Application Data
(63) Continuation-in-part of application No. 13/174,885, filed on Jul. 1, 2011, now abandoned.

(51) Int. Cl. B32B 3/00; B32B 37/12; B32B 37/24; B29C 41/42; B29C 41/02

(52) U.S. Cl. 428/195.1; 264/334; 156/242

(57) ABSTRACT

A decoration layer of a laminated product includes first and second surfaces. The first surface is adapted to be engaged with a furnishing surface of a pattern transforming member. The first surface includes a decorating pattern determined by a decorating mold shape extended on the furnishing surface. The second surface is adapted to be engaged with a carrying layer. The decoration layer laminated with the carrying layer and the adhesive layer is adapted to embellish an object and includes the pattern transforming member separated therefrom, with the carrying layer disposed between the decorating layer and the adhesive layer, with the adhesive layer adhered to the object.

### CROSS REFERENCE

The present application is a continuation-in-part application of U.S. patent application Ser. No. 13/174,885, filed on Jul. 1, 2011, of which the entire disclosure is incorporated herein.

### BACKGROUND OF THE INVENTION

1. Field of the Invention

The present invention relates to a decoration layer of a laminated product and method of manufacture thereof.

2. Description of the Related Art

Current coated and laminated fabrics are usually produced via coating or adhering PVC (polyvinyl chloride) film on fabric. However, PVC is not degradable and is not an environment-friendly material. Further, if the PVC coated fabric has a pattern on the surface thereof, the coating PVC will hide the pattern lines. It results in lack of aesthetics of the current, coated, laminated fabric products.

TPU (thermoplastic polyurethane) is a new raw material for manufacturing of laminated fabric and has a degradation capability at the normal atmospheric temperature, so that TPU is a kind of environment-friendly material. TPU and PVC are both water-repellent, but the air permeability of TPU is greater that the air permeability of PVC. A film made of TPU has nice resilience so as to be deformed easily by any external force. The transparency of the TPU film is great, too. Currently, there are two processes for printing patterns or images on a TPU laminated fabric. The first process is printing the desired pattern or images onto a base fabric first, and then, attaching a TPU film with the printed base fabric. The second process is attaching the TPU film with the base fabric first, and then printing the desired pattern or images onto the TPU film. However, the shortcoming of the first process is that the surface of the base fabric is rough, so that the printed pattern of images would lack an aesthetic presentation. The shortcoming of the second process is that the pattern or images are printed on the outside of the TPU laminated fabric so that the pattern or images are easy to be worn-off.

The present invention is, therefore, intended to obviate or at least alleviate the problems encountered in the prior art.

### SUMMARY OF THE INVENTION

According to the present invention, a decoration layer of a laminated product includes first and second surfaces. The first surface is adapted to be engaged with a furnishing surface of a pattern transforming member. The first surface includes a decorating pattern determined by a decorating mold shape extended on the furnishing surface. The second surface is adapted to be engaged with a carrying layer. The decoration layer laminated with the carrying layer and the adhesive layer is adapted to embellish an object and includes the pattern transforming member separated therefrom, with the carrying layer disposed between the decorating layer and the adhesive layer, with the adhesive layer adhered to the object.

Additionally, a method of making the decoration layer includes steps: releasably engaging the pattern transforming member with the decorating layer and separating the pattern transforming member from the decorating layer to allow the decorating pattern to be exposed. Furthermore, a method of making the laminated product includes steps: releasably engaging the pattern transforming member with the decorating layer, adhering the carrying layer and the adhesive layer to the second surface of the decorating layer, and forming the laminated product that includes the pattern transforming member disengaged from the decorating layer and includes the decorating layer, the carrying layer, and the adhesive layer stacked together.

Other objects, advantages, and new features of the present invention will become apparent from the following detailed description of the invention when considered in conjunction with the accompanied drawings.

### BRIEF DESCRIPTION OF THE DRAWINGS

FIG. 1 shows forming of a decorating layer of a laminated product in accordance with the present invention.

FIG. 2 is a cross-sectional view showing the decorating layer overlapped on a pattern transforming member of FIG. 1.

FIG. 3 is a continued cross-sectional view of FIG. 2 and shows the decorating layer and the pattern transforming member be disposed on one of two opposite sides of a first carrying layer and shows an adhesive layer overlapped on the other side of the carrying layer.

FIG. 4 is a continued cross-sectional view of FIG. 3 and shows the pattern transforming member, the decorating layer, the carrying layer, and the adhesive layer sequentially stacked together.

FIG. 5 is a continued cross-sectional view of FIG. 4 showing the pattern transforming member disengaged from the decorating layer.

FIG. 6 is a continued cross-sectional view of FIG. 2 and shows the decorating layer and the pattern transforming member be disposed on one of two opposite sides of a second carrying layer, which is different form the first carrying layer of FIG. 3, and shows the adhesive layer overlapped on the other side of the second carrying layer.

FIG. 7 is a continued cross-sectional view of FIG. 6 and shows the pattern transforming member, the decorating layer, the carrying layer, and the adhesive layer sequentially stacked together.

FIG. 8 is a continued cross-sectional view of FIG. 7 showing the pattern transforming member disengaged from the decorating layer.

FIG. 9 illustrates the method of making a laminated product in accordance with the present invention.

FIG. 10 is a perspective view of a laminated product in accordance with the present invention.

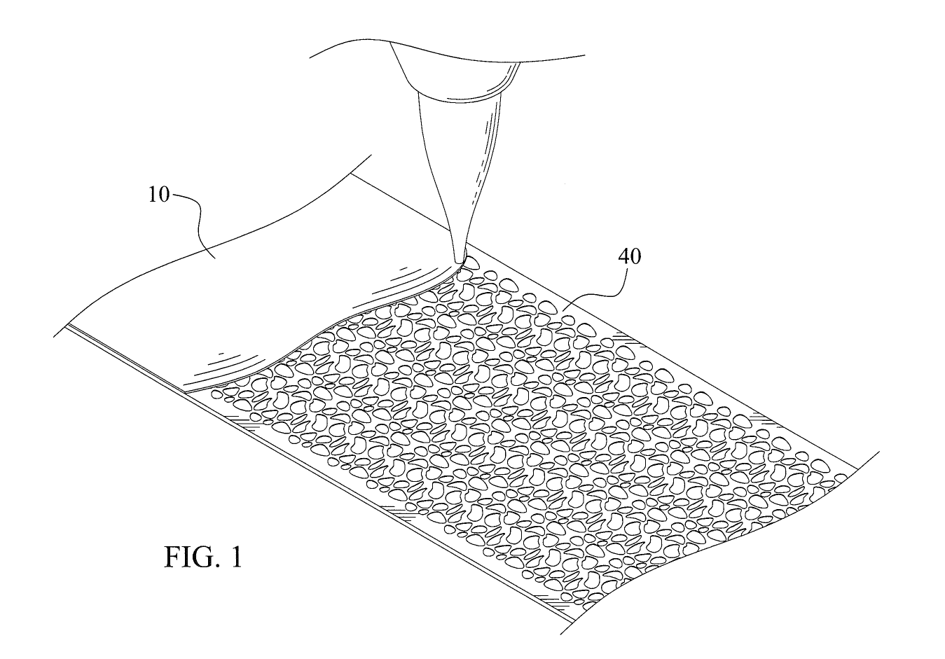

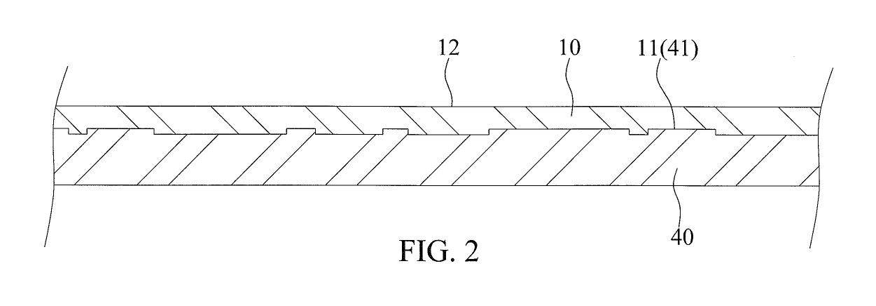

### DETAILED DESCRIPTION OF THE PREFERRED EMBODIMENT

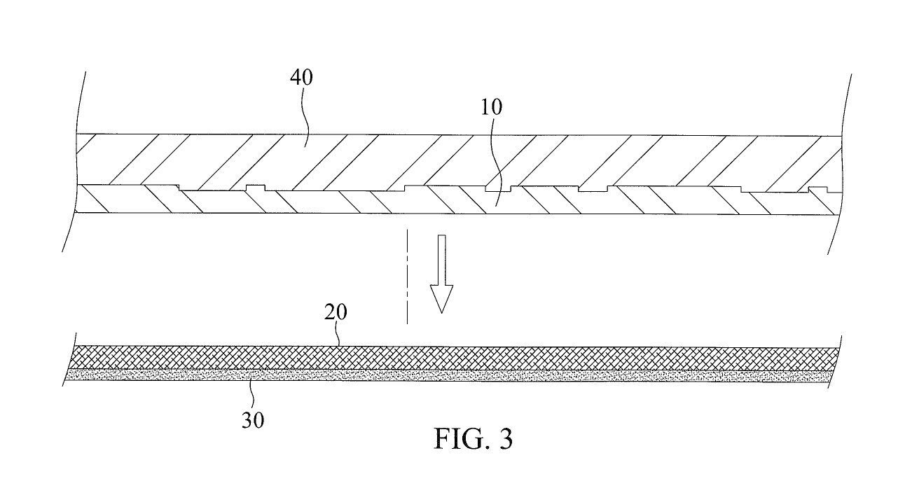

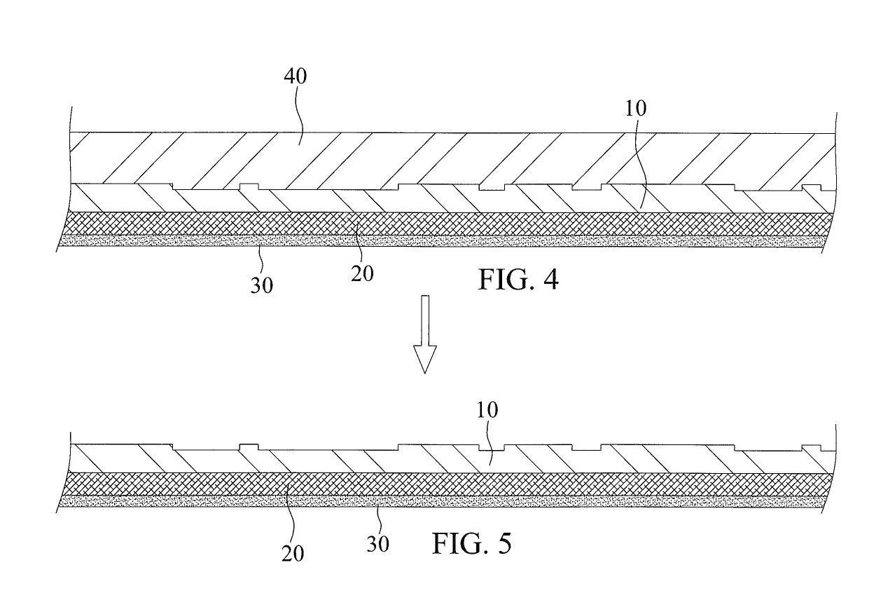

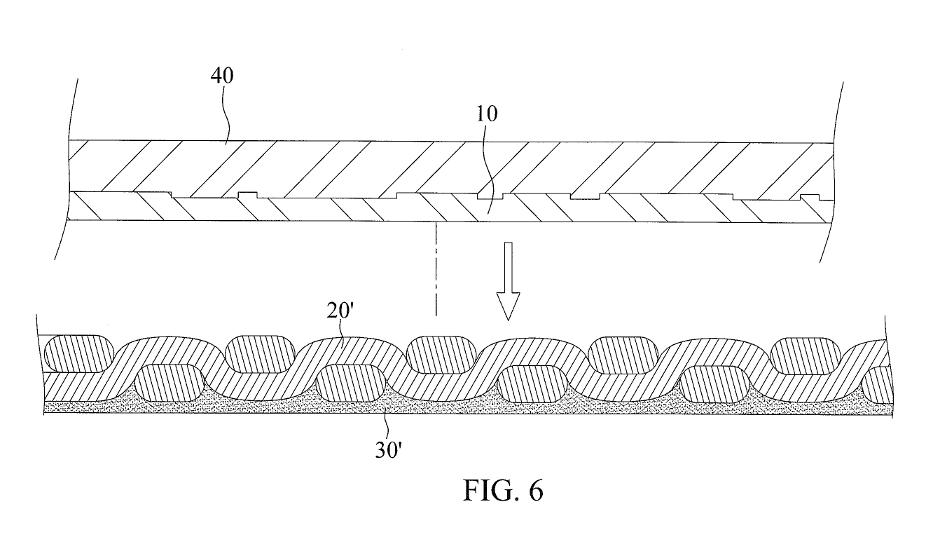

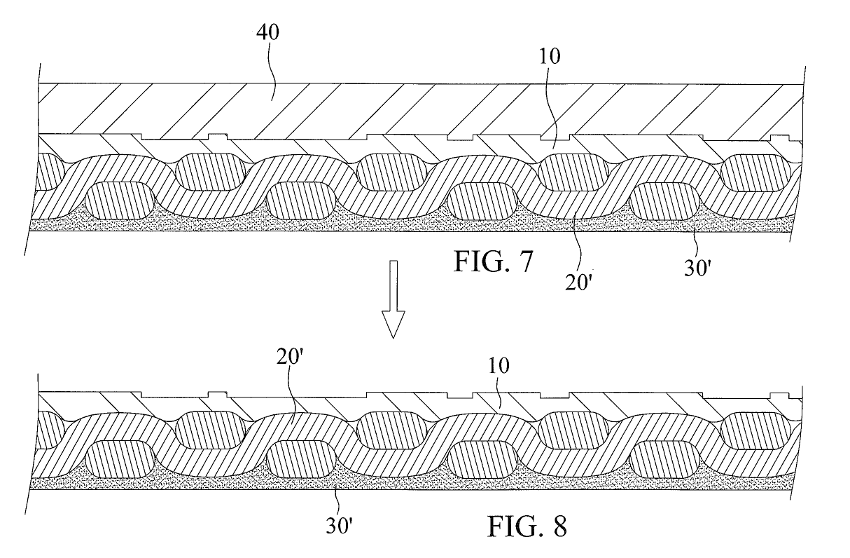

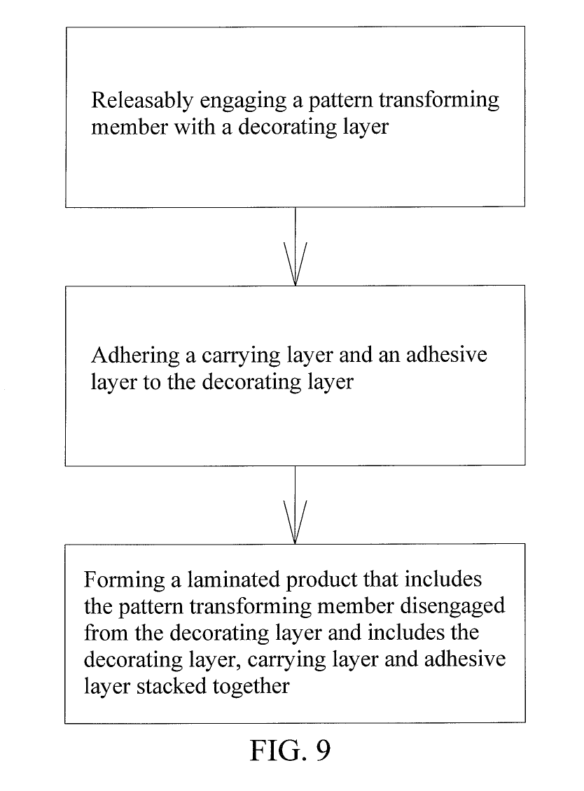

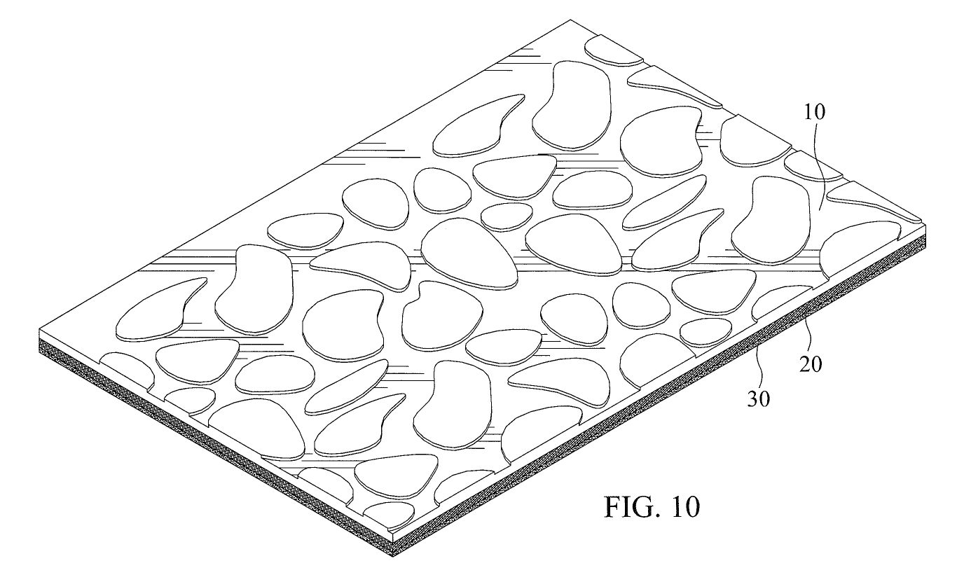

A decorating layer 10 of a laminated product is made of polyurethane material. The decoration layer 10 includes first and second surfaces 11 and 12. The first surface 11 is adapted to be engaged with a furnishing surface 41 of a pattern transforming member 40. The first surface 11 includes a decorating pattern determined by a decorating mold shape extended on the furnishing surface 41. The pattern transforming member 40 can be a release paper, which is adapted to be separated from the decorating layer 10 to allow the decorating pattern to be exposed. The pattern transforming member 40 can also be a mold, which is adapted to be moved away from the decorating layer 10. The second surface 12 is adapted to be engaged with a first carrying layer 20, which is made of thermoplastic polyurethane (TPU) material (FIG. 3). Moreover, the second surface 12 is adapted to be engaged with a second carrying layer 20′, which is a fabric (FIG. 6). The decoration layer 10 laminated with the any one of the first and second carrying layers 20 and 20′ and the adhesive layer 30 is adapted to embellish an object and includes the pattern transforming member 40 separated therefrom, with any one of the first and second carrying layers 20 and 20′ disposed between the decorating layer 10 and the adhesive layer 30, with the adhesive layer 30 adhered to the object. The object is preferably a shoe.

Additionally, a method of making the decoration layer 10 includes steps: releasably engaging the pattern transforming member 40 with the decorating layer 10 and separating the pattern transforming member 40 from the decorating layer 10 to allow the decorating pattern to be exposed.

Furthermore, a method of making the laminated product includes steps: releasably engaging the pattern transforming member 40 with the decorating layer 10, adhering one of the carrying layers 20 and 20′ and the adhesive layer 30 to the second surface 12 of the decorating layer 10, and forming the laminated product that includes the pattern transforming member 40 disengaged from the decorating layer 10 and includes the decorating layer 10, any one of the carrying layers 20 and 20′, and the adhesive layer 30 stacked together.

While the specific embodiment has been illustrated and described, numerous modifications come to mind without significantly departing from the spirit of invention, and the scope of invention is only limited by the scope of the accompanying claims.

What is claimed is:

1. A decoration layer of a laminated product, comprising:
a first surface adapted to be engaged with a furnishing surface of a pattern transforming member, with the first surface including a decorating pattern determined by a decorating mold shape extended on the furnishing surface; and
a second surface adapted to be engaged with a carrying layer;
wherein the decoration layer laminated with the carrying layer and the adhesive layer is adapted to embellish an object and includes the pattern transforming member separated therefrom, with the carrying layer disposed between the decorating layer and the adhesive layer, with the adhesive layer adhered to the object.

2. The decorating layer as claimed in claim 1, wherein the pattern transforming member is a release paper adapted to be separated from the decorating layer.

3. The decorating layer as claimed in claim 1, wherein the pattern transforming member is a mold.

4. The decorating layer as claimed in claim 1, wherein the decorating layer is made of polyurethane material.

5. The decorating layer as claimed in claim 1, wherein the carrying layer is made of thermoplastic polyurethane material.

6. The decorating layer as claimed in claim 1, wherein the carrying layer is a fabric.

7. The decorating layer as claimed in claim 1, wherein the decorating layer is adhered on a shoe.

8. A method of making a decoration layer of a laminated product including steps:
releasably engaging a pattern transforming member with the decorating layer, with the decorating layer including a first surface, with the first surface adapted to be engaged with a furnishing surface of the pattern transforming member, with the first surface including a decorating pattern determined by a decorating mold shape extended on the furnishing surface; and
separating the pattern transforming member from the decorating layer to allow the decorating pattern to be exposed.

9. The method as claimed in claim 8, wherein the pattern transforming member is a release paper adapted to be separated from the decorating layer.

10. The method as claimed in claim 8, wherein the pattern transforming member is a mold.

11. The method as claimed in claim 8, wherein the decorating layer is made of polyurethane material.

12. The method as claimed in claim 8, wherein the decorating layer is adapted to be laminated with a carrying layer and an adhesive layer, with the carrying layer disposed between the decorating layer and the adhesive layer, wherein the decorating layer is adapted to adhered to an object by the adhesive layer.

13. The method as claimed in claim 12, wherein the object is a shoe.

14. A method of making a laminated product including steps:
releasably engaging a pattern transforming member with a decorating layer, with the decorating layer including a first surface, and a second surface, with the first surface adapted to be engaged with a furnishing surface of the pattern transforming member, with the first surface including a decorating pattern determined by a decorating mold shape extended on the furnishing surface;
adhering a carrying layer and an adhesive layer to the second surface of the decorating layer, with the second surface adhered to the carrying layer, with the carrying layer adhered to an adhesive layer, with the carrying layer disposed between the decorating layer and the adhesive layer;
forming a laminated product that includes the pattern transforming member disengaged from the decorating layer and includes the decorating layer, the carrying layer, and the adhesive layer stacked together.

15. The method as claimed in claim 14, wherein the pattern transforming member is a release paper adapted to be separated from the decorating layer.

16. The method as claimed in claim 14, wherein the pattern transforming member is a mold.

17. The method as claimed in claim 14, wherein the decorating layer is made of polyurethane material.

18. The method as claimed in claim 14, wherein the carrying layer is made of thermoplastic polyurethane material.

19. The method as claimed in claim 14, wherein the carrying layer is a fabric.

20. The method as claimed in claim 1, wherein the decorating layer is adapted to be adhered to an object by the adhesive layer, wherein the object is a shoe.
